(19) United States
(12) Patent Application Publication
(10) Pub. No.: US 2026/0322988 A1
(43) Pub. Date: Oct. 15, 2026

(54) STEREOSCOPIC IMAGE DISPLAY DEVICE

(71) Applicant: Industrial Technology Research Institute, Hsinchu (TW)

(72) Inventors: Yi-Hsiang Huang, Changhua County (TW); Hung Tsou, Hsinchu County (TW); Szu-Wei Wu, Taoyuan City (TW); Chia-Ping Lin, Hsinchu City (TW)

(73) Assignee: Industrial Technology Research Institute, Hsinchu (TW)

(21) Appl. No.: 19/550,307

(22) Filed: Feb. 26, 2026

Related U.S. Application Data
(60) Provisional application No. 63/788,837, filed on Apr. 15, 2025.

(30) Foreign Application Priority Data
Sep. 25, 2025 (TW) 114136946

(51) Int. Cl. H04N 13/346; G02B 5/18; G02B 30/50; H04N 13/302

(52) U.S. Cl. CPC H04N 13/346; G02B 5/1814; G02B 30/50; H04N 13/302

(57) ABSTRACT

A stereoscopic image display device including a light source module, an image generator, a lens element array and a light redirection element is provided. The light source module is disposed to generate an illumination light. The image generator is disposed to convert the illumination light into an image light. The lens element array is disposed on a path of the image light. The image light changes a traveling direction thereof through the light redirection element.

### CROSS-REFERENCE TO RELATED APPLICATIONS

This application claims priority to and the benefit of U.S. Provisional Application No. 63/788,837, filed on Apr. 15, 2025 and Taiwan Application No. 114136946, filed on Sep. 25, 2025. The entirety of each of the above-mentioned patent applications is hereby incorporated by reference herein and made a part of this specification.

### TECHNICAL FIELD

The disclosure relates to an optical device, and also relates to a stereoscopic image display device.

### BACKGROUND

The existing stereoscopic image display device requires a head-mounted device to form a stereoscopic image, and cannot perform stereoscopic display in a transparent medium, lacking a naked-eye display solution.

### SUMMARY

Embodiments of the disclosure provide a stereoscopic image display device, able to serve as a naked-eye virtual reality device.

According to an embodiment of the disclosure, a stereoscopic image display device is provided. The stereoscopic image display device includes a light source module, an image generator, a lens element array, and a light redirection element. The light source module is disposed to generate an illumination light. The image generator is disposed to convert the illumination light into an image light. The lens element array is disposed on a path of the image light. The image light changes a traveling direction thereof through the light redirection element.

Based on the above, the stereoscopic image display device provided in the embodiments of the disclosure utilizes the image generator to generate a virtual stereoscopic image, and utilizes the light redirection element to change the traveling direction of the image light. The stereoscopic image display device can be imaged in the light redirection element, and is realized as a naked-eye virtual reality device.

To make the disclosure more comprehensible, several embodiments accompanied with drawings are described in detail as follows.

### BRIEF DESCRIPTION OF THE DRAWINGS

FIGS. 1-8 respectively show schematic diagrams of stereoscopic image display devices according to a first embodiment to an eighth embodiment of the disclosure.

### DETAILED DESCRIPTION OF DISCLOSED EMBODIMENTS

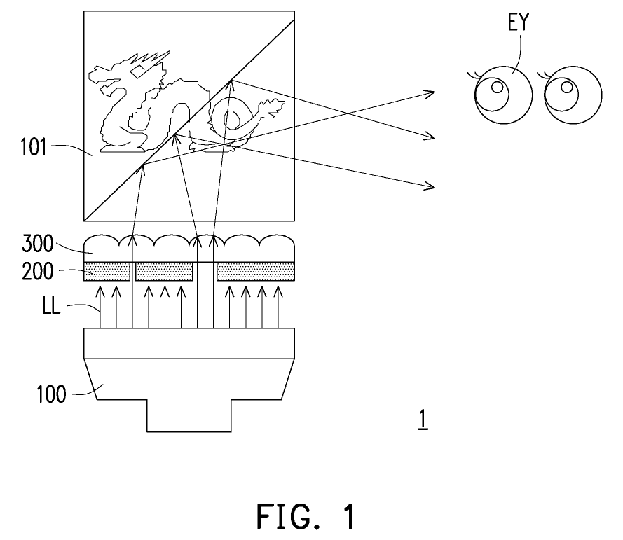

Referring to FIG. 1, a schematic diagram of a stereoscopic image display device according to a first embodiment of the disclosure is shown.

A stereoscopic image display device 1 includes a light source module 100, an image generator 200, a lens element array 300, and a cube prism 101. The light source module 100 is configured to provide an illumination light LL. The image generator 200 is configured to convert the illumination light LL into an image light. The lens element array 300 is disposed on a path of the image light. The image light is changed in a traveling direction thereof through the cube prism 101, so as to enter eyes EY of a user.

Specifically, the image generator 200 can be, for example, an imaging plate or a display panel. The imaging plate can be a glass board or a PET plastic board substrate having stereoscopic image data, manufactured by a photo-lithographic process, a screen-printing process, or a printing process, in which stereoscopic image data can be designed by using an algorithm, with an objective of allowing a user to see a virtual stereoscopic image in the cube prism 101. Since the cube prism 101 is light-transmissive, the user can simultaneously see the virtual stereoscopic image and a real environment image. In other words, the user can see a virtual reality image in the cube prism 101.

In order to fully describe various embodiments of the disclosure, other embodiments of the disclosure will be described below. It should be noted here that the following embodiments reuse element reference numerals and part of the contents of the foregoing embodiment, in which the same reference numerals are adopted to indicate the same or similar elements, and descriptions of the same technical contents are omitted. Descriptions regarding the omitted parts can be referred to the foregoing embodiment, and the following embodiments will not repeat and give redundant descriptions.

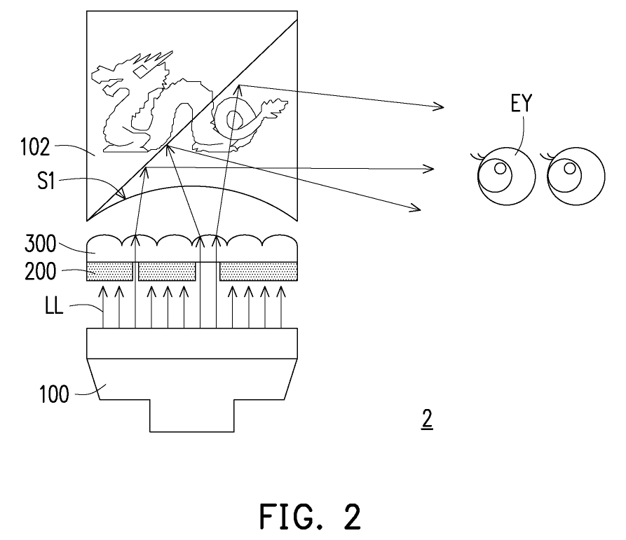

Referring to FIG. 2, a schematic diagram of a stereoscopic image display device according to a second embodiment of the disclosure is shown.

A stereoscopic image display device 2 includes a light source module 100, an image generator 200, a lens element array 300, and a cube prism 102. The light source module 100 is configured to provide an illumination light LL. The image generator 200 is configured to convert the illumination light LL into an image light. The lens element array 300 is disposed on a path of the image light. The image light is changed in a traveling direction thereof through the cube prism 102, so as to enter eyes EY of a user. A difference between the stereoscopic image display device 2 and the stereoscopic image display device 1 mainly lies in that an incident surface S1 of the cube prism 102 is a concave surface, thereby increasing a light receiving angle of the cube prism 102.

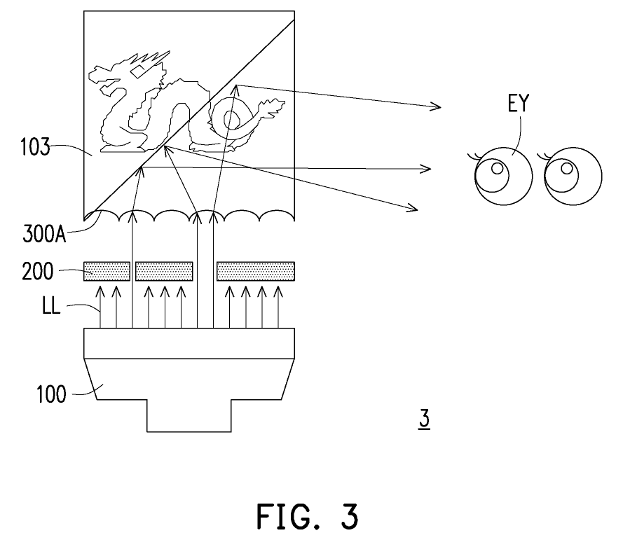

Referring to FIG. 3, a schematic diagram of a stereoscopic image display device according to a third embodiment of the disclosure is shown.

A stereoscopic image display device 3 includes a light source module 100, an image generator 200, a lens element array 300A, and a cube prism 103. The light source module 100 is configured to provide an illumination light LL. The image generator 200 is configured to convert the illumination light LL into an image light. The lens element array 300A is disposed on a path of the image light. The image light is changed in a traveling direction thereof through the cube prism 103, so as to enter eyes EY of a user. A difference between the stereoscopic image display device 3 and the stereoscopic image display device 1 mainly lies in that the lens element array 300A and the cube prism 103 are integrally formed. The lens element array 300A includes a plurality of concave lenses with concave surfaces facing the image generator 200, thereby increasing an amount of light coupled into the cube prism 103.

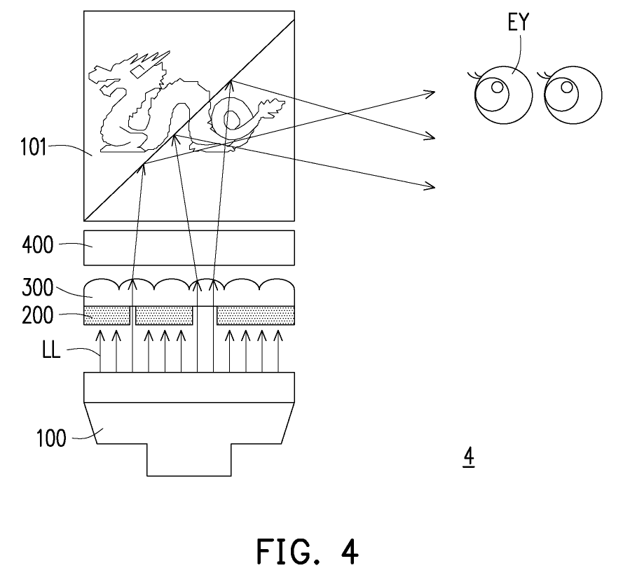

Referring to FIG. 4, a schematic diagram of a stereoscopic image display device according to a fourth embodiment of the disclosure is shown.

A stereoscopic image display device 4 includes a light source module 100, an image generator 200, a lens element array 300, a sensing module 400, and a cube prism 101. The light source module 100 is configured to provide an illumination light LL. The image generator 200 is configured to convert the illumination light LL into an image light, and simulate light entering eyes EY of a user by using an algorithm. The sensing module 400 is disposed on a path of the image light, and can be implemented as a floating touch sensor, and includes one of an infrared sensor, a projected capacitive sensor, and a radar. For example, the sensing module 400 can emit infrared rays, and sense infrared rays reflected from the user by the infrared sensor, so as to sense and identify an operation gesture of the user. It should be noted that the sensing module 400 is not limited to being disposed on an incident side of the cube prism 101. In some embodiments, the sensing module 400 can be disposed on an emergent side of the cube prism 101, or on another side different from the incident side and the emergent side.

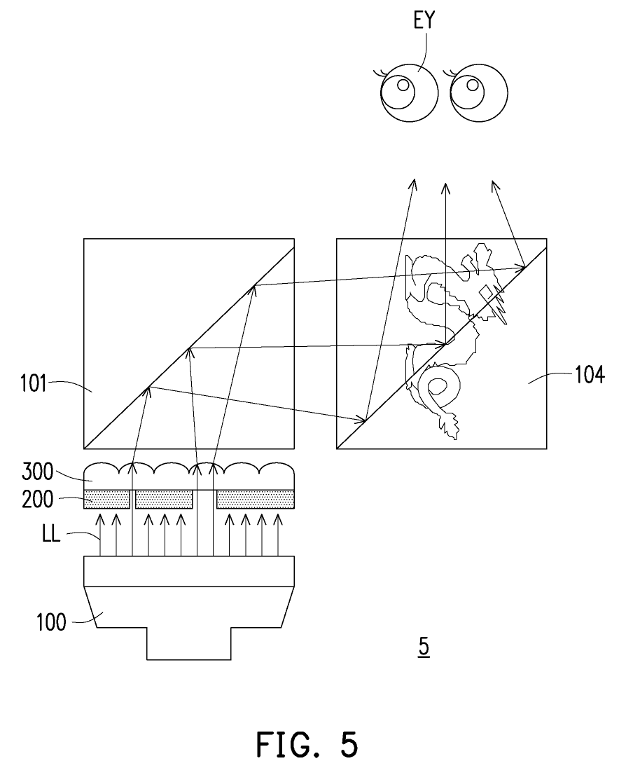

Referring to FIG. 5, a schematic diagram of a stereoscopic image display device according to a fifth embodiment of the disclosure is shown.

A stereoscopic image display device 5 includes a light source module 100, an image generator 200, a lens element array 300, a cube prism 101, and a cube prism 104. The light source module 100 is configured to provide an illumination light LL. The image generator 200 is configured to convert the illumination light LL into an image light. The lens element array 300 is disposed on a path of the image light. The image light is changed in a traveling direction thereof through the cube prism 101 and the cube prism 104, so as to enter eyes EY of a user. It should be noted that the stereoscopic image display device provided according to the embodiment of the disclosure is not limited to having one or two cube prisms, and a number of the cube prisms can be greater than 2, and an orientation suitable for viewing a virtual image is determined according to an arrangement manner of the cube prisms.

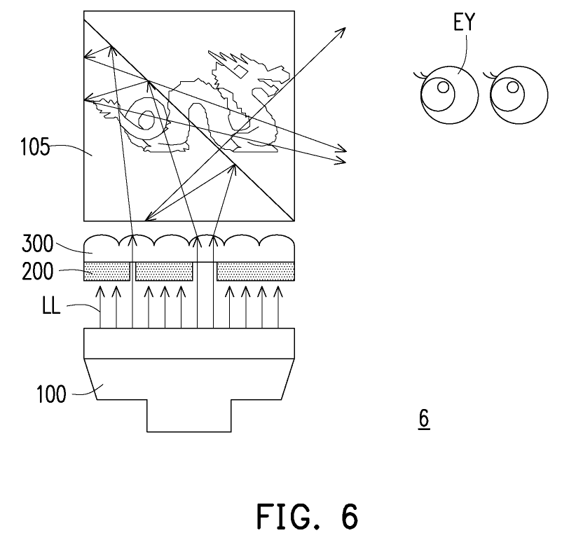

Referring to FIG. 6, a schematic diagram of a stereoscopic image display device according to a sixth embodiment of the disclosure is shown.

A stereoscopic image display device 6 includes a light source module 100, an image generator 200, a lens element array 300, and a cube prism 105. The light source module 100 is configured to provide an illumination light LL. The image generator 200 is configured to convert the illumination light LL into an image light. The lens element array 300 is disposed on a path of the image light. The image light is changed in a traveling direction thereof through the cube prism 105, so as to enter eyes EY of a user. A difference between the stereoscopic image display device 6 and the stereoscopic image display device 1 mainly lies in that the image light in the cube prism 101 of the stereoscopic image display device 1 enters the eyes EY of the user after being reflected once, and the image light in the cube prism 105 of the stereoscopic image display device 6 enters the eyes EY of the user after being reflected at least twice.

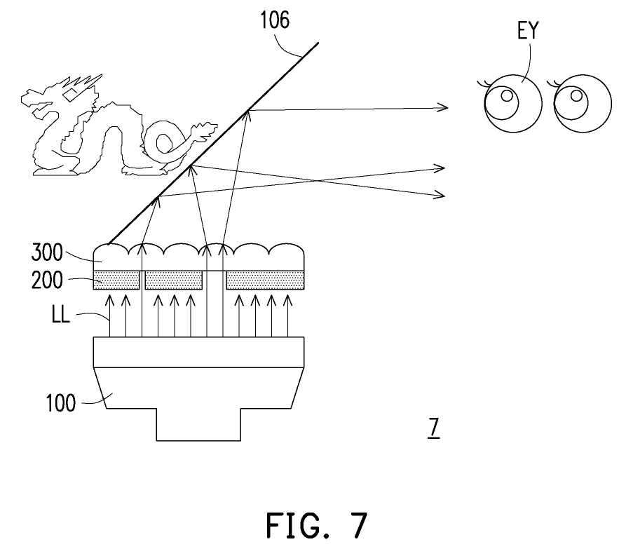

Referring to FIG. 7, a schematic diagram of a stereoscopic image display device according to a seventh embodiment of the disclosure is shown.

A stereoscopic image display device 7 includes a light source module 100, an image generator 200, a lens element array 300, and a mirror 106. The light source module 100 is configured to provide an illumination light LL. The image generator 200 is configured to convert the illumination light LL into an image light. The lens element array 300 is disposed on a path of the image light. The image light is changed in a traveling direction thereof through the mirror 106, so as to enter eyes EY of a user. The image generator 200 can be, for example, an imaging plate or a display panel, which simulates light entering the eyes EY of the user by using an algorithm, with an objective of allowing the user to see a virtual stereoscopic image in the mirror 106.

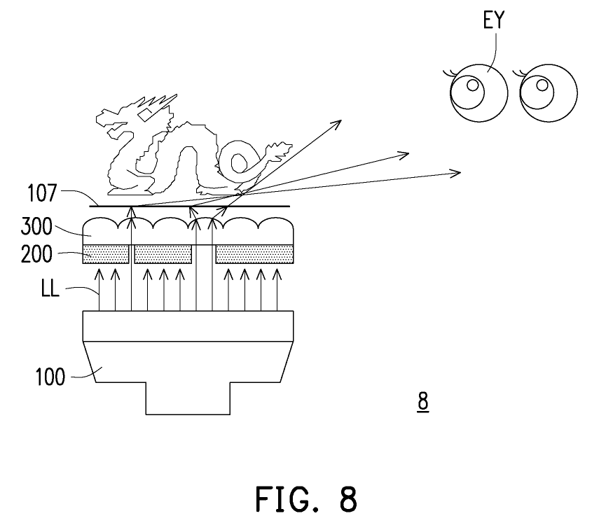

Referring to FIG. 8, a schematic diagram of a stereoscopic image display device according to an eighth embodiment of the disclosure is shown.

A stereoscopic image display device 8 includes a light source module 100, an image generator 200, a lens element array 300, and a diffraction grating 107. The light source module 100 is configured to provide an illumination light LL. The image generator 200 is configured to convert the illumination light LL into an image light. The lens element array 300 is disposed on a path of the image light. The image light is changed in a traveling direction thereof through the diffraction grating 107, so as to enter eyes EY of a user. The image generator 200 can be, for example, an imaging plate or a display panel, which simulates light entering the eyes EY of the user by using an algorithm, with an objective of allowing the user to see a virtual stereoscopic image above the diffraction grating 107.

In summary, the stereoscopic image display device provided in the embodiment of the disclosure utilizes the image generator to generate a virtual stereoscopic image, and utilizes various light redirection elements such as cube prisms, mirrors, and diffraction gratings to change the traveling direction of the image light, thereby increasing the freedom of use. The stereoscopic image display device can be imaged in the light redirection element, and is realized as a naked-eye virtual reality device.

What is claimed is:

1. A stereoscopic image display device, comprising:
a light source module, disposed to generate an illumination light;
an image generator, disposed to convert the illumination light into an image light;
a lens element array, disposed on a path of the image light; and
a light redirection element, wherein the image light changes a traveling direction thereof through the light redirection element.

2. The stereoscopic image display device according to claim 1, wherein the light redirection element comprises at least one cube prism.

3. The stereoscopic image display device according to claim 2, wherein the at least one cube prism is configured to provide a virtual reality image.

4. The stereoscopic image display device according to claim 2, wherein the at least one cube prism comprises an incident surface, and the incident surface is a concave surface.

5. The stereoscopic image display device according to claim 2, wherein the at least one cube prism comprises a plurality of cube prisms.

6. The stereoscopic image display device according to claim 2, wherein the image light is reflected at least twice in the at least one cube prism.

7. The stereoscopic image display device according to claim 1, wherein the lens element array and the light redirection element are integrally formed.

8. The stereoscopic image display device according to claim 1, further comprising a sensing module disposed on the path of the image light.

9. The stereoscopic image display device according to claim 1, suitable for serving as a naked-eye virtual reality device.

10. The stereoscopic image display device according to claim 1, wherein the light redirection element comprises a mirror.

11. The stereoscopic image display device according to claim 1, wherein the light redirection element comprises a diffraction grating.
